(19) United States
(12) Patent Application Publication
(10) Pub. No.: US 2026/0360200 A1
(43) Pub. Date: Nov. 12, 2026

(54) METHOD FOR ACTIVATING A VEHICLE FUNCTION AND ASSOCIATED ACTIVATION APPARATUS

(71) Applicant: AUMOVIO GERMANY GMBH, Frankfurt am Main (DE)

(72) Inventors: Mohamed CHEIKH, L'Union (FR); Sébastien KESSLER, Drémil - lafage (FR); Alain BRILLON, Villeneuve Toloane (FR)

(73) Assignee: Continental Automotive Technologies GmbH, Hannover (DE)

(21) Appl. No.: 19/476,969

(22) PCT Filed: Apr. 9, 2024
(86) PCT No.: PCT/EP2024/059569

§ 371 Date: Oct. 20, 2025

(30) Foreign Application Priority Data
Apr. 21, 2023 (FR) FR2304037

(51) Int. Cl. G07C 9/00; H04B 1/7163; H04B 17/309; H04B 17/318; H04W 12/06

(52) U.S. Cl. CPC G07C 9/00309; H04B 1/7163; H04B 17/318; H04B 17/346; H04W 12/06; G07C 2209/63

(57) ABSTRACT

A method for activating a vehicle function, using an activation device, from a user's “hands-free” access device, the method including: transmitting a request over ultra-high frequency to a plurality of access devices; receiving the request and acquiring, over a predetermined duration for each device, values from the magnetometer, accelerometer and gyroscope integrated into the device; determining an approach vector for each device based on the values thus acquired; if the number of access devices is greater than a threshold, then: determining a correlation coefficient between the various approach vectors; consolidating access devices with correlated approach vectors; comparing at least one received transmissions parameter from the same group; selecting, from the same communication group, the access device as a function of a value of the at least one parameter; detecting the presence of the user in a predetermined zone and authenticating the user over ultra-wideband using the access device thus selected.

### CROSS-REFERENCE TO RELATED APPLICATIONS

This application is the U.S. National Phase Application of PCT International Application No. PCT/EP2024/059569, filed Apr. 9, 2024, which claims priority to French Patent Application No. FR2304037, filed Apr. 21, 2023, the contents of such applications being incorporated by reference herein.

### DESCRIPTION

### Field of the Invention

The invention relates to a method for activating a function of a motor vehicle and an associated activation device. The invention specifically, but in a non-limiting manner, applies to the function involving hands-free access to a motor vehicle using a smartphone, with the function involving, for example, locking and unlocking the opening elements of a motor vehicle.

### Background of the Invention

In a motor vehicle, it is known practice to use devices for activating a vehicle function that are able to detect the presence of a hand or a foot of a user of the vehicle and thus allow all or some of the opening elements of the vehicle, for example, the doors or the trunk, to be locked or unlocked. By way of an example, the detection of the presence of a hand of a user on or in front of a door handle coupled with the recognition of an identifier of a “hands-free” access device carried by this user allows these opening elements to be locked and unlocked.

A “hands-free” access system for accessing a motor vehicle allows an authorized user to lock and/or unlock the opening elements of their vehicle without having to physically press buttons on a key. For this purpose, the vehicle identifies a portable device such as a fob or a remote control or even a key carried by the user and, if the fob or the remote control or indeed the key is located in a predetermined zone around the vehicle or in the vehicle and is identified as belonging to the vehicle, then the vehicle automatically locks/unlocks its opening elements according to the intention of the user, without the user having to physically manipulate a key.

To do this, when the user approaches the vehicle, a communication is established over a wireless communication link between the “hands-free” access device, for example, an electronic fob or a smartphone, and the device for activating a vehicle function in order to authenticate said access device using its identifier.

To this end, the activation device comprises at least one radiofrequency antenna allowing the identifier sent by the “hands-free” access device to be received. The activation device is connected to an electronic control unit (ECU) of the vehicle to which it transmits the identifier.

According to the prior art, the access device is generally an electronic fob. The signal received by the antenna of the activation device, containing the identifier of the access device, is sent via RF (Radio Frequency) or LF (Low Frequency) waves. The portable device is precisely located around the vehicle by measuring the strength of the RF signal received by the portable device (via the antennas and the electronic control unit) from the vehicle, more commonly called RSSI (received signal strength indicator) measurements. The measurement of the strength of each signal received by the portable device from each antenna of the plurality of RF antennas located in the vehicle V is received and analyzed by an activation device installed in the vehicle, which thus determines, via triangulation, the position of the portable device relative to said RF antennas, i.e., relative to the vehicle.

Depending on the location of the portable device identified by the vehicle, in said location zones, some actions specific to said location zones are automatically carried out, namely, unlocking/locking or turning on welcome lighting in the passenger compartment in advance.

Nowadays, however, it is increasingly common to use a cell phone to perform authentication functions, which avoids having to use a dedicated electronic fob and thus limits the number of devices. Most cell phones do not have RF or LF communication means. It is then necessary to adapt the “hands-free” access and/or start-up system for a vehicle in order for it to also be able to operate with a mobile telephone equipped with other communication standards, such as, for example, ultra-wideband, UWB, or Bluetooth Low Energy®, or Wi-Fi (Wireless Fidelity) communication and no longer only via radio and low-frequency (RF and LF) waves. Ultra-wide band (UWB) in particular is a radio modulation technique that is based on transmitting very short duration pulses, often of less than a nanosecond. Thus, the bandwidth can reach very large values.

Bluetooth communication, for its part, involves communication at a frequency in the region of 2.4 GHz.

The disadvantage of using Bluetooth (ultra-high frequency) lies in the imprecision of the location of the mobile telephone. Bluetooth experiences a lot of interference, which makes locating imprecise. In addition, locating the mobile telephone notably varies from one telephone to another.

It is then recommended that ultra-wideband is used to locate the mobile telephone more precisely.

The method for activating a vehicle function using a mobile telephone then involves:
detecting, via Bluetooth communication, the distant presence of the access device, i.e., in the region of 100 m around the vehicle, and establishing a first Bluetooth communication link between the access device and the activation device;
recognizing the identifier received by the vehicle via Bluetooth;
remotely activating certain vehicle functions if necessary, for example unlocking the vehicle by pressing a button on the remote control, activating the air conditioning, but also turning on the air conditioning, the heating, the radio, for example; or indeed
detecting, via UWB, the immediate presence of the access device, i.e., within a radius of a few meters, for example, 10 m, around the vehicle, and precisely locating the position of said device;
activating the vehicle function when the device is detected as approaching the door or the hand is detected as being in close contact with the door, i.e., unlocking.

The activation method thus described operates reliably when communication is established between the vehicle and a mobile telephone. However, when the number of access devices connected to the vehicle over UWB increases, for example not only mobile telephones, but also smart watches, the probability of collisions between the UWB transmissions with the various devices and the vehicle significantly increases, thereby affecting the location of said devices. This is illustrated in FIG. 1, which shows the probability P of collisions between the UWB transmissions as a function of the number of connected devices. It would appear that, based on four devices simultaneously connected to the vehicle, the probability of collision reaches 40%, i.e., 40% of the transmissions are not reliable enough for a precise location to be established.

Locating becomes completely impossible with eight devices connected to the vehicle at the same time because the collision probability of the transmissions approaches 100%.

The activation method of the prior art prioritizes the access devices that are detected first. However, sometimes said access devices, when the user moves toward the vehicle, are not the access devices with the most reliable transmissions for establishing a precise location. It is then detrimental to fail to consider the other devices.

Therefore, an aspect of the invention proposes a method for activating a vehicle function and an associated activation device for detecting the intention of the user to unlock (or to lock) their vehicle.

### SUMMARY OF THE INVENTION

An aspect of the invention relates to a method for activating a vehicle function, using an activation device, from a “hands-free” access device carried by a user equipped with a magnetometer, an accelerometer and a gyroscope, with the activation of the function being triggered by detecting the presence of the device in a predetermined zone around the vehicle, and as a function of an authentication result relating to the device, the activation device comprising at least one transceiver able to communicate with said device over ultra-wideband and ultra-high frequency, the method being characterized in that it comprises the following steps of:
a. transmitting a request over ultra-high frequency to a plurality of access devices;
b. receiving the request by the plurality of devices and acquiring, over a predetermined duration for each device, values from the magnetometer, the accelerometer and the gyroscope;
c. determining an approach vector for each device based on the values of the magnetometer, the accelerometer and the gyroscope thus acquired over the predetermined duration;
d. if the number of access devices is greater than a threshold, then:
   i. determining a correlation coefficient between the various approach vectors;
   ii. consolidating the devices with approach vectors whose mutual correlation coefficient is greater than a predetermined correlation coefficient value into communication groups;
   iii. comparing, between the access devices from the same communication group, at least one transmissions parameter received by the activation device;
   iv. selecting, from among the access devices from the same communication group, the access device as a function of a value of the at least one parameter;
   v. detecting the presence of the user in a predetermined zone and authenticating the user over ultra-wideband using the access device thus selected.

Appropriately, the transmissions parameter is:
a. a total strength of the received transmissions; or
b. a signal-to-noise ratio; or
c. a power spectral density and in that the access device with the highest total strength or signal-to-noise ratio or spectral density is selected.

Alternatively, the received transmissions parameter is a time of flight or a type of visibility of the received transmissions and in that the access device with transmissions with the lowest time of flight or with direct visibility is selected.

An aspect of the invention also relates to a device for activating a vehicle function equipped with a magnetometer, an accelerometer and a gyroscope, with the activation of the function being triggered by detecting the presence of a “hands-free” access device in a predetermined zone around the vehicle, and as a function of an authentication result relating to said device, the activation device comprising at least one transceiver able to communicate with said device over ultra-wideband and ultra-high frequency, said device being characterized in that in a first embodiment of the invention it comprises:
a. ultra-high frequency reception means for receiving values relating to the gyroscope, the magnetometer and the accelerometer, with said values originating from a plurality of access devices and being acquired over a predetermined duration;
b. means for determining an approach vector for each device based on the values of the magnetometer, the accelerometer and the gyroscope thus acquired over the predetermined duration;
c. means for determining a correlation coefficient between the various approach vectors;
d. means for consolidating the devices with approach vectors whose mutual correlation coefficient is greater than a predetermined correlation coefficient value into communication groups;
e. means for comparing, between the access devices from the same communication group, at least one received transmissions parameter;
f. means for selecting, from among the access devices from the same communication group, the access device according to a value of the at least one parameter;
g. means for detecting the presence of the user in a predetermined zone and for authenticating the user over ultra-wideband using the access device thus selected.

In a second embodiment of the invention, the device for activating a vehicle function is equipped with a magnetometer, an accelerometer and a gyroscope, with the activation of the function being triggered by detecting the presence of a “hands-free” access device in a predetermined zone around the vehicle, and as a function of an authentication result relating to said device, the activation device comprising at least one transceiver able to communicate with said device over ultra-wideband and ultra-high frequency, said device being characterized in that it comprises:
a. ultra-high frequency reception means for receiving approach vectors from a plurality of access devices that are determined based on values relating to the magnetometer, the accelerometer and the gyroscope thus acquired over the predetermined duration;
b. means for determining a correlation coefficient between the various approach vectors;
c. means for consolidating the devices with approach vectors whose mutual correlation coefficient is greater than a predetermined correlation coefficient value into communication groups;
d. means for comparing, between the access devices from the same communication group, at least one received transmissions parameter;
e. means for selecting, from among the plurality of access devices from the same communication group, the access device as a function of the at least one received transmissions parameter;
f. means for detecting the presence of the user in a predetermined zone and for authenticating the user over ultra-wideband using the access device thus selected.

Appropriately, the parameter is a total strength of the received transmissions, or a signal-to-noise ratio, or a power spectral density.

Alternatively, the parameter is a time of flight or a type of visibility of the received transmissions.

An aspect of the invention also applies to any computer program product comprising program code instructions for executing the steps of the method according to the features listed above when said program is executed on a computer.

In the second embodiment, the invention also relates to an access device, characterized in that it comprises a magnetometer, an accelerometer, a gyroscope, means for acquiring the values of the magnetometer, the accelerometer and the gyroscope over a predetermined duration, means for determining an approach vector, based on the values of the magnetometer, the accelerometer and the gyroscope thus acquired over the predetermined duration, and means for the ultra-high frequency transmission of the approach vector thus determined.

Furthermore, for the first embodiment, the invention relates to any access device, characterized in that it comprises a magnetometer, an accelerometer, a gyroscope, means for acquiring the values of the magnetometer, the accelerometer and the gyroscope over a predetermined duration and means for the ultra-high frequency transmission of said values thus determined.

Finally, an aspect of the invention applies to any motor vehicle comprising an activation device according to any one of the features listed above.

### BRIEF DESCRIPTION OF THE DRAWINGS

Further features and advantages of aspects of the invention will become more clearly apparent upon reading the following description. This description is purely illustrative and should be read with reference to the attached drawings, in which:

FIG. 1 is a graph showing the probability, according to the number of access devices connected to the vehicle over UWB, of collisions of the transmissions between said devices and the vehicle;

FIG. 2 is a graph showing the continuous measurements of the accelerometer, the gyroscope and the magnetometer contained in the access device for multiple states of the user, namely, standing, approaching, turning, distancing and standing again;

FIG. 3 is a three-dimensional graph, showing the approach vector of the access device, along the axes showing the speed, the orientation and the number of steps between three consecutive movement instants;

FIG. 4 is a three-dimensional graph, showing the approach vectors of four access devices illustrated in FIG. 5 around the vehicle, and along the axes showing the speed, the orientation and the number of steps, for five consecutive movement instants of the user;

FIG. 5 is a schematic view showing three users each carrying at least one access device and each performing different movements relative to the vehicle;

FIG. 6 is a diagram showing seven access devices consolidated per user carrying them according to the activation method according to an aspect of the invention;

FIG. 7 is a flowchart illustrating the activation method according to an aspect of the invention;

FIG. 8 schematically shows the activation device according to an aspect of the invention.

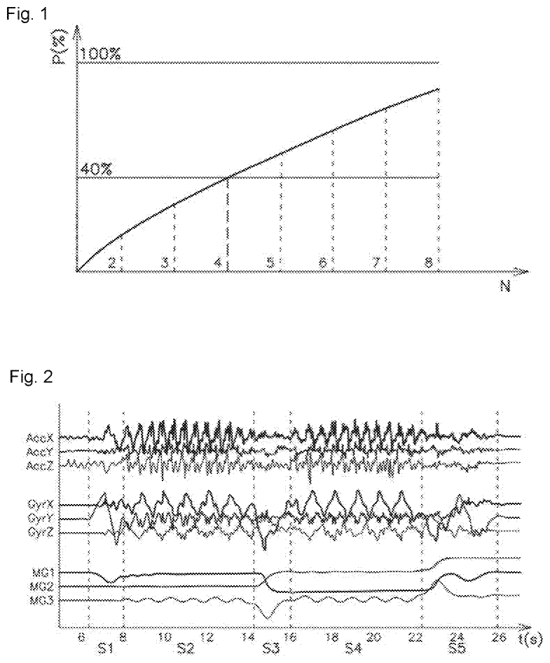

### DETAILED DESCRIPTION OF EXEMPLARY EMBODIMENTS

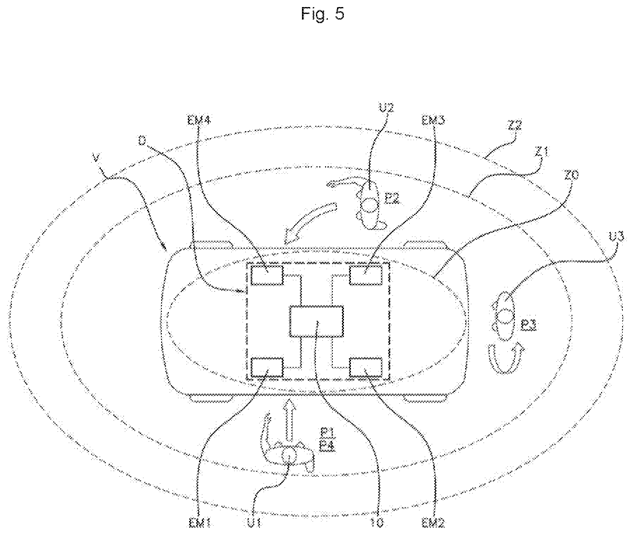

FIG. 5 shows a motor vehicle V equipped with the activation device D according to an aspect of the invention. The activation device D comprises four antenna modules EM1, EM2, EM3, EM4 for transceiving over ultra-wideband UWB and ultra-high frequency BLE able to communicate over ultra-wide band UWB and ultra-high frequency Bluetooth Low Energy (BLE) in a zone Z1, Z2 around the vehicle V with a portable access device P1 carried by a user U. The BLE communication is activated when the portable device P1 is in a remote zone Z2 around the vehicle; the ultra-wideband communication is activated when the portable device P1 is in a close zone Z1 around the vehicle V or in the passenger compartment Z0 of the vehicle V.

The activation device D further comprises a central control unit 10 electronically connected to all the antenna modules EM1, EM2, EM3 and EM4.

This central control unit 10 allows the transmission and the reception of the UWB and Bluetooth (BLE) data to be managed via the antenna modules. This is known from the prior art and will not be described in further detail herein.

Ultra-wideband (UWB) communication is understood to mean radiofrequency communication that is based on the transmission of very short duration pulses, often of less than a nanosecond. Thus, the bandwidth can reach very large values between 250 and 500 MHz.

Bluetooth LE (Bluetooth Low Energy) communication is understood to mean ultra-high-frequency communication in the region of 2.4 GHz.

According to the prior art, when a number of portable access devices P1, P2 . . . Pn connected over Ultra Wide Band (UWB) to the activation device D exceeds a predetermined threshold, the number of collisions between the transmissions originating from said devices is such that precisely locating each device is then impossible.

The portable devices P1 . . . Pn can be smartphones, smart watches, tablets, computers, etc.

An aspect of the invention proposes an activation method and device for overcoming this disadvantage of the prior art.

In this case, according to an aspect of the invention each portable device P1, P2 . . . Pn is provided with a magnetometer MG, an accelerometer Acc and a gyroscope Gyr.

If an orthonormal coordinate system (O, x, y, z) is defined, the accelerometer Acc provides acceleration measurements for the access device Pi over the three dimensions AccX, AccY, AccZ. Similarly, the gyroscope Gyr provides orientation measurements GyrX, GyrY, GyrZ over the three dimensions and, finally, the magnetometer MG provides values representing the yaw MG1, the pitch MG2 and the roll MG3 of the access device Pi over the three dimensions. This is illustrated in FIG. 2. FIG. 2 shows the acceleration AccX, AccY, AccZ, orientation GyrX, GyrY, GyrZ and yaw MG1, pitch MG2 and roll MG3 values in three dimensions for a portable device P1 carried by a user U completing a series of several movements:
a. during the first movement S1, the user U is standing and walking toward the vehicle V;
b. during the second movement S2, the user U continues walking and approaches the vehicle V;
c. during the third movement S3, the user U completes an about turn and turns by 180°;
d. during the fourth movement S4, the user walks away from the vehicle V;
e. during the last movement S5, the user U is still standing and continues to move away from the vehicle.

According to an aspect of the invention, the portable device P1, P2 . . . Pn, is also able to measure, over a predetermined duration Δt, the values of the gyroscope GyrX, GyrY, GyrZ, the accelerometer AccX, AccY, AccZ and the magnetometer MG1, MG2, MG3 and to transmit said values thus measured to the activation device D over ultra-high frequency (BLE).

According to an aspect of the invention, the activation device D for its part is capable of:
a. receiving values relating to the gyroscope GyrX, GyrY, GyrZ, the magnetometer MG1, MG2, MG3 and the accelerometer AccX, AccY, AccZ over ultra-high frequency (BLE), with said values originating from a plurality of access devices P1, P2 . . . Pn and being acquired over a predetermined duration Δt;
b. determining an approach vector \vec{V1}, \vec{V2} . . . \vec{Vn} for each device P1, P2 . . . Pn based on the values of the magnetometer MG1, MG2, MG3, the accelerometer AccX, AccY, AccZ and the gyroscope GyrX, GyrY, GyrZ thus acquired over the predetermined duration;
c. determining a correlation coefficient ki between the various approach vectors \vec{V1}, \vec{V2} . . . \vec{Vn};
d. consolidating devices P1, P2 . . . Pn with approach vectors whose mutual correlation coefficient ki is greater than a predetermined correlation coefficient value ks into communication groups G1, G2 . . . Gk;
e. comparing, between the access devices from the same communication group G1, G2 . . . Gn, a parameter of the transmissions received by the activation device D;
f. selecting, from among the access devices P1, P2 . . . Pn from the same communication group G1, G2 . . . Gk, the access device Pi according to said received transmissions parameter;
g. detecting the presence of the user U in a predetermined zone Z2, Z1 and authenticating the user over ultra-wideband using the access device Pi thus selected.

To this end, the activation device D comprises:
a. ultra-high frequency (BLE) reception means M1 for receiving values relating to the gyroscope GyrX, GyrY, GyrZ, the magnetometer MG1, MG2, MG3 and the accelerometer AccX, AccY, AccZ, with said values originating from a plurality of access devices P1, P2 . . . Pn and being determined over a predetermined duration Δt;
b. means M2 for determining an approach vector [symbol] , [symbol] . . . [symbol] for each device P1, P2 . . . Pn based on the values of the magnetometer MG1, MG2, MG3, the accelerometer AccX, AccY, AccZ and the gyroscope GyrX, GyrY, GyrZ thus acquired over the predetermined duration Δt;
c. means M3 for determining a correlation coefficient ki between the various approach vectors [symbol] , [symbol] . . . [symbol] ;
d. means M4 for consolidating devices P1, P2 . . . Pn with approach vectors whose mutual correlation coefficient ki is greater than a predetermined correlation coefficient value ks into the same communication group G1, G2 . . . Gk;
e. means M5 for comparing, between the access devices from the same communication group G1, G2 . . . Gn, a parameter of the transmissions received by the activation device D;
f. means M6 for selecting, from among the access devices P1, P2 . . . Pn from the same communication group G1, G2 . . . Gk, the access device Pi using said parameter;
g. means M7 for detecting the presence of the user U in a predetermined zone Z2, Z1 and for authenticating the user over ultra-wideband (UWB) using the access device Pi thus selected.

The reception means M1, the means M2 for determining an approach vector, the means M3 for determining a correlation coefficient, the consolidation means M4, the comparison means M5, the selection means M6 and the detection means M7 are, for example, in the form of software included in the central control unit 10. This is illustrated in FIG. 8.

The selection means M6 allow an access device Pi to be selected according to at least one of the parameters of the received transmissions, i.e., according to one of the following communication parameters or according to a combination of the following parameters:

Said parameter can be made up of one of the following parameters or a combination of several of the following parameters:
a. a total strength of the received transmissions RSSImax;
b. a signal-to-noise ratio Rsmax;
c. a power spectral density Dmax;
d. a time of flight TOFmin;
e. a type of direct or indirect visibility of the transmissions Vdi.

Appropriately, the selection means M6 select, from each communication group G1 . . . Gk, the access device Pi with:
a. the highest total strength RSSimax of the transmissions received by the activation device D;
b. the highest signal-to-noise ratio Rsmax of the transmissions received by the activation device D;
c. the highest power spectral density Dmax of the transmissions received by the activation device D;
d. the shortest time of flight TOFmin of the transmissions received by the activation device D;
e. direct visibility of the transmissions Vdi received by the activation device “Line of Sight”.

The use of at least one parameter according to the criterion described above allows the selection means M6 to select the access device Pi from each communication group G1 . . . Gk that has the most reliable communication with the activation device D. Said parameters are known to a person skilled in the art, and will not be described in further detail herein.

The activation device D also comprises a processor 100 and a memory 101 (see FIG. 8) that stores instructions for configuring the processor to execute certain particular processing operations, notably to implement the steps of the method for activating a vehicle function according to the embodiment as described hereafter.

In a second embodiment of the invention, the means M2 for determining an approach vector are not included in the activation device D but in the portable device P1, P2 . . . Pn. Said device P1, P2 . . . PN is then able to determine an approach vector [symbol] , [symbol] . . . [symbol] as a function of the gyroscope Gyr, the magnetometer MG and the accelerometer Acc values that have been acquired over the predetermined duration Δt, and the activation device D is, for its part, able to receive, from the plurality of access devices P1, P2 . . . Pn, said approach vectors thus determined by the devices themselves.

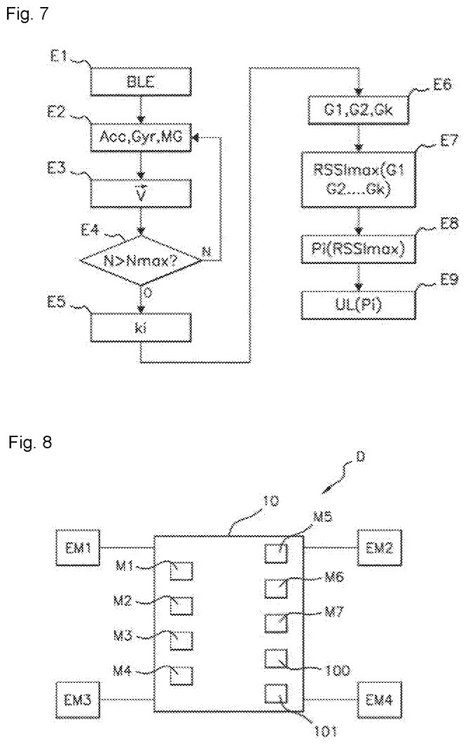

The activation method according to an aspect of the invention, illustrated in FIG. 7, will now be described.

During a first step E1, ultra-high frequency (BLE) communication is established between the activation device D and a plurality of portable devices P1, P2 . . . Pn located within the BLE communication range around the vehicle V. During this communication, a request R is sent by the activation device D to the plurality of access devices P1, P2 . . . Pn.

During a second step E2, the request R is received by the plurality of access devices P1, P2 . . . Pn and said access devices then measure the values of their integrated magnetometer MG1, MG2, MG3, accelerometer AccX, AccY, AccZ, gyroscope GyrX, GyrY, GyrZ over a predetermined duration Δt.

During a third step E3, in the preferred embodiment of the method according to an aspect of the invention, said values acquired by the plurality of access devices P1 . . . Pn are sent over ultra-high frequency (BLE) to the activation device D and said device D then determines at least one or more consecutive approach vectors [symbol] , [symbol] . . . [symbol] for each device P1 . . . Pn using said values it has received.

It is worthwhile determining at least two consecutive approach vectors, between three consecutive movement instants of the user U, i.e., over two consecutive predetermined durations.

In a second embodiment of the method according to the invention, this step of determining the approach vectors is carried out by the access device P1 . . . Pn itself by virtue of the values it has measured itself.

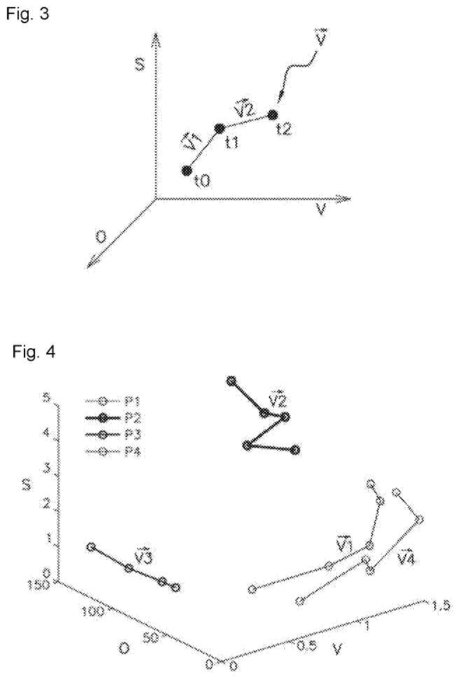

The method for computing or determining an approach vector [symbol] , [symbol] . . . [symbol] based on the values of a gyroscope GyrX, GyrY, GyrZ, a magnetometer MG1, MG2, MG3 and an accelerometer AccX, AccY, AccZ acquired consecutively over time is known to a person skilled in the art. This method is called “dead reckoning navigation” or “pedestrian dead reckoning”; it is a known navigation method of the prior art that allows the speed and the direction of an object or of a person to be estimated. This is illustrated in FIG. 3.

FIG. 3 is a graph showing a series of two approach vectors \vec{V1}, \vec{V2} between the consecutive instants t0, t1 and t2, i.e., over two consecutive predetermined durations Δt1 (between t0 and t1) and Δt2 (between t1 and t2) in three dimensions, along the orientation O, speed V and number of steps S axes.

During a fourth step E4, the number of access devices N currently connected to the vehicle V over ultra-high frequency (BLE) is counted. If the number N of connected devices is less than a threshold Nmax, then the method returns to the second step E2 of measuring the gyroscope, magnetometer and accelerometer values for each of the plurality of access devices P1 . . . Pn currently connected to the device D over ultra-high frequency (BLE), including “new” access devices that have since appeared since the last BLE connection.

Otherwise, if the number N of connected devices is greater than the threshold Nmax, then the activation method according to an aspect of the invention proposes, in the fifth step E5, determining a correlation coefficient ki between the various approach vectors [symbol] , [symbol] . . . [symbol] .

The computation of the correlation coefficient ki is known to a person skilled in the art; it can use a linear regression or any other method for determining a mathematical link between two approach vectors originating from two different access devices; more specifically, there is a strong correlation coefficient ki between two approach vectors when these have substantially the same orientation O, the same movement speed V and the same number of steps S.

It should be noted that, with the number N of devices connected to the vehicle V being able to change over time, it is essential that the approach vectors are determined as early as possible in the method, i.e., upon receiving the ultra-high frequency (BLE) request R from the activation device D.

Indeed, the generation of the approach vector can be time-consuming. If other access devices P1 . . . Pn connect to the vehicle V, while the user approaches the vehicle, the approach vectors need to be obtained as early as possible in order to implement the method according to an aspect of the invention.

Then, during a sixth step E6, the access devices P1, P2 . . . Pn whose approach vectors have a correlation coefficient ki greater than a predetermined correlation coefficient value ks, for example, ks=0.7, are consolidated into communication groups G1, G2 . . . Gk. Indeed, the activation method according to an aspect of the invention is based on the applicant finding that access devices P1, P2 . . . Pn carried by the same user U1, U2, U3 have similar and strongly correlated approach vectors. The method therefore proposes, as explained hereafter, not using all the access devices P1 . . . Pn carried by the same user in order to locate and authenticate them, but to only use the access device with the most reliable communication with the activation device D, i.e., using a parameter of the received transmissions as described hereafter.

FIG. 4 shows four approach vectors [symbol] , [symbol] , [symbol] , [symbol] according to the orientation O, the speed V and the number of steps S that are determined between five consecutive instants for four different access devices P1, P2, P3, P4, respectively, illustrated in FIG. 5. It would appear that the approach vectors [symbol] and [symbol] are strongly correlated; indeed, they have the same direction, the same speed and the same number of steps over time. Indeed, the access devices P1 and P4 are carried by the same user U3, as illustrated in FIG. 5.

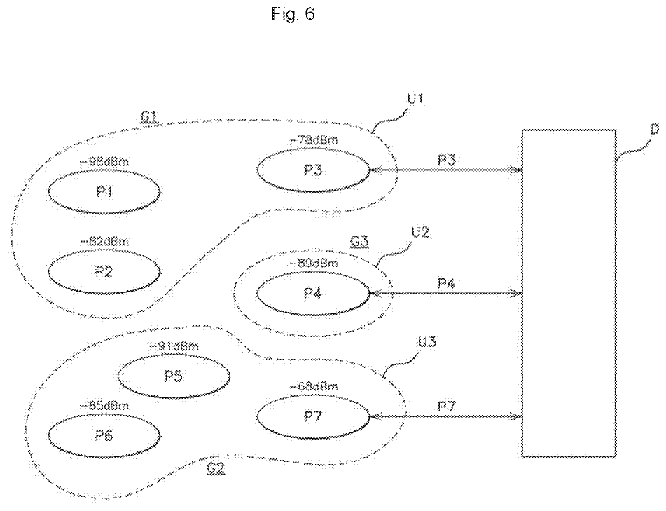

Another example is illustrated in FIG. 6. FIG. 6 shows seven portable access devices P1, P2 . . . P7 all simultaneously connected to the activation device D. The devices P1, P2, P3 have strongly correlated approach vectors (not shown); according to an aspect of the invention it is concluded that these devices P1, P2, P3 are carried by the same user, and the method therefore consolidates them into a first communication group G1.

Similarly, the devices P5, P6, P7 have strongly correlated approach vectors (not shown); according to an aspect of the invention it is concluded that they are carried by a second user. The method therefore consolidates them into a second communication group G2.

The approach vector of the access device P4 has no correlation with the approach vectors of the six other access devices; the access device P4 therefore appears to be the only device carried by a third user and alone constitutes a third communication group G3.

During a seventh step E7, a comparison is undertaken between the access devices of the same communication group G1, G2 . . . Gk using at least one reception parameter of the transmissions received by the activation device D.

Said parameter can be made up of one of the following parameters or a combination of several of the following parameters:
a. a total strength of the received transmissions RSSImax;
b. a signal-to-noise ratio Rsmax;
c. a power spectral density Dmax;
d. a time of flight TOFmin;
e. a type of direct or indirect visibility of the transmissions Vdi.

In addition, during an eighth step E8, the access device Pi is selected from the communication group G1 . . . Gk according to one of the parameters listed above or according to a combination of several of the parameters listed above.

More specifically, according to an aspect of the invention, an access device Pi is selected that has, from among all the access devices P1 . . . Pn from the same communication group G1 . . . Gk:
a. the highest total strength RSSimax of the transmissions received by the activation device D;
b. the highest signal-to-noise ratio Rsmax of the transmissions received by the activation device D;
c. the highest power spectral density Dmax of the transmissions received by the activation device D;
d. the shortest time of flight TOFmin of the transmissions received by the activation device D;
e. direct visibility Vdi of the transmissions received by the activation device D, also called “Line of Sight”.

The use of at least one parameter according to the above criterion allows the access device Pi that has the most reliable communication with the activation device D to be selected from the communication group G1 . . . Gk. Said parameters are known to a person skilled in the art, and will not be described in further detail herein.

During the ninth and final step E9, the location of the user U and their ultra-wideband (UWB) authentication are then carried out using only the access device Pi thus selected for each communication group G1 . . . Gk.

This is illustrated in FIG. 6 for the received transmissions strength RSSImax parameter. In the first group G1, the access device with the highest reception strength is the device P3, the strength of which is equal to −78 dBm; the location of the first user U1 carrying the access devices P1, P2, and P3 is therefore established with only one access device, namely, the access device P3.

In the second group, the access device with the highest reception strength is the device P7, the strength of which is equal to −68 dBm; the location of the second user U2 carrying the access devices P5, P6, and P7 is therefore established with only one access device, namely, the access device P7.

With the third user U3 carrying only one access device P4, the location and the authentication of the third user U3 is then established by the sole device they are carrying, namely, the device P4.

By thereby selecting only one access device from a plurality of access devices carried by the user to locate and authenticate the user, this reduces the total number of devices connected to the vehicle and consequently the number of collisions in the transmissions. The ultra-wideband communication is then more reliable and more sound, thus making locating more precise and authentication more secure.

Therefore, the invention is advantageous since it allows the major disadvantage of the prior art to be overcome by selecting the access devices the vehicle can communicate with.

The invention is all the more ingenious since its implementation is simple and inexpensive, as it is implemented by software means.

1. A method for activating a vehicle function, using an activation device, from a “hands-free” access device carried by a user equipped with a magnetometer, an accelerometer and a gyroscope, with the activation of the function being triggered by detecting the presence of the device in a predetermined zone around the vehicle, and as a function of an authentication result relating to the device, the activation device comprising at least one transceiver able to communicate with said device over ultra-wideband and ultra-high frequency, the method comprising:
a) transmitting a request over ultra-high frequency to a plurality of access devices;
b) the plurality of access devices receiving the request and acquiring, over a predetermined duration for each device, values from the magnetometer, the accelerometer and the gyroscope;
c) determining an approach vector for each device based on the values of the magnetometer, the accelerometer and the gyroscope thus acquired over the predetermined duration;
d) if the number of access devices is greater than a threshold (Nmax), then:
i) determining a correlation coefficient between the various approach vectors,
ii) consolidating the devices with approach vectors whose mutual correlation coefficient is greater than a predetermined correlation coefficient value into communication groups;
then, for each communication group:
iii) comparing, between the access devices from the same communication group, at least one transmissions parameter received by the activation device;
iv) selecting, from among the plurality of access devices from the same communication group, the access device as a function of a value of the at least one parameter;
v) detecting the presence of the user in a predetermined zone and authenticating the user over ultra-wideband using the access device thus selected.

2. The activation method as claimed in claim 1, wherein the received transmissions parameter is a total strength of the received transmissions, or a signal-to-noise ratio, or a power spectral density and in that the access device with the highest total strength or signal-to-noise ratio or spectral density is selected.

3. The activation method as claimed in claim 1, wherein the received transmissions parameter is a time of flight or a type of visibility of the received transmissions and in that the access device with transmissions with the lowest time of flight or with direct visibility is selected.

4. A device for activating a vehicle function, with the activation of the function being triggered by detecting the presence of a “hands-free” access device equipped with a magnetometer, an accelerometer and a gyroscope in a predetermined zone around the vehicle, and as a function of an authentication result relating to said device, the activation device comprising at least one transceiver able to communicate with said device over ultra-wideband and ultra-high frequency, said device comprising:
a) ultra-high frequency reception means for receiving values relating to the gyroscope, the magnetometer and the accelerometer, with said values originating from a plurality of access devices and being acquired over a predetermined duration;
b) means for determining an approach vector for each device based on the values of the magnetometer, the accelerometer and the gyroscope thus acquired over the predetermined duration;
c) means for determining a correlation coefficient between the various approach vectors as a function of a comparison between a number of access devices and a threshold;
d) means for consolidating the access devices with approach vectors whose mutual correlation coefficient is greater than a predetermined correlation coefficient value into communication groups;
e) means for comparing, between the plurality of access devices from the same communication group, at least one received transmissions parameter;
f) means for selecting, from among the access devices from the same communication group, the access device according to a value of the at least one parameter;
g) means for detecting the presence of the user in a predetermined zone and for authenticating the user over ultra-wideband using the access device thus selected.

5. A device for activating a vehicle function, with the activation of the function being triggered by detecting the presence of a “hands-free” access device equipped with a magnetometer, an accelerometer and a gyroscope in a predetermined zone around the vehicle, and as a function of an authentication result relating to said device, the activation device comprising at least one transceiver able to communicate with said device over ultra-wideband and ultra-high frequency, said device comprising:
a) ultra-high frequency reception means for receiving approach vectors from a plurality of access devices that are determined based on values relating to the magnetometer, the accelerometer and the gyroscope thus acquired over the predetermined duration;
b) means for determining a correlation coefficient between the various approach vectors as a function of a comparison between a number of access devices and a threshold;
c) means for consolidating access devices with approach vectors whose mutual correlation coefficient is greater than a predetermined correlation coefficient value into communication groups;
d) means for comparing, between the plurality of access devices from the same communication group, at least one received transmissions parameter;
e) means for selecting, from among the plurality of access devices from the same communication group, the access device as a function of the at least one received transmissions parameter;
f) means for detecting the presence of the user in a predetermined zone and for authenticating the user over ultra-wideband using the access device thus selected.

6. The activation device as claimed in claim 4, wherein the parameter is a total strength of the received transmissions, or a signal-to-noise ratio, or a power spectral density.

7. The activation device as claimed in claim 4, wherein the parameter is a time of flight or a type of visibility of the received transmissions.

8. A computer program product comprising program code instructions for executing the steps of the method as claimed in claim 1, when said program is executed on a computer.

9. A portable access device, comprising a magnetometer, an accelerometer, a gyroscope, means for acquiring the values of the magnetometer, the accelerometer and the gyroscope over a predetermined duration, means for determining an approach vector, based on the values of the magnetometer, the accelerometer and the gyroscope thus acquired over the predetermined duration, and means for the ultra-high frequency transmission of the approach vector thus determined.

10. A portable access device, comprising a magnetometer, an accelerometer, a gyroscope, means for acquiring the values of the magnetometer, the accelerometer and the gyroscope over a predetermined duration and means for the ultra-high frequency transmission of said values thus acquired.

11. A motor vehicle, comprising an activation device as claimed in claim 4.

12. The activation device as claimed in claim 5, wherein the parameter is a total strength of the received transmissions, or a signal-to-noise ratio, or a power spectral density.

13. The activation device as claimed in claim 5, wherein the parameter is a time of flight or a type of visibility of the received transmissions.
